(19) United States
(12) Patent Application Publication
(10) Pub. No.: US 2017/0060593 A1
(43) Pub. Date: Mar. 2, 2017

(54) HIERARCHICAL REGISTER FILE SYSTEM

(71) Applicant: QUALCOMM Incorporated, San Diego, CA (US)

(72) Inventors: Anil KRISHNA, Raleigh, NC (US); Rodney Wayne SMITH, Raleigh, NC (US); Sandeep Suresh NAVADA, Knightdale, NC (US); Shivam PRIYADARSHI, Raleigh, NC (US); Niket Kumar CHOUDHARY, Raleigh, NC (US); Raguram DAMODARAN, Raleigh, NC (US)

(21) Appl. No.: 14/843,921

(22) Filed: Sep. 2, 2015

(51) Int. Cl. G06F 9/30; G06F 9/38

(52) U.S. Cl. CPC G06F 9/30105; G06F 9/3867

(57) ABSTRACT

Systems and methods relate to a hierarchical register file system including a level 1 physical register file (L1 PRF) and a backing physical register file (PRF). A subset of productions of instructions executed in an instruction pipeline of a processor which have a high likelihood of use for one or more future instructions are identified. The subset of productions are stored in the L1 PRF, while all productions are stored in the backing PRF.

### FIELD OF DISCLOSURE

Disclosed aspects relate to register files used in processing systems. More specifically, exemplary aspects relate to a processing system comprising a hierarchical register file system which includes a physical register file (PRF) and a level 1 (L) PRF, where the L1 PRF holds a subset of logical registers or, alternatively, a subset of physical registers.

### BACKGROUND

In a processor, a set of instructions that are being actively processed constitute an instruction window. Large instruction windows enable greater performance by including more instructions in the instruction window, which means that execution of instructions in the instruction window can commence earlier. To create large instruction windows, conventional techniques involve control flow speculation and register renaming, which may be employed by processors which support instruction execution out of program order, or out-of-order (OOO) processors. These techniques will be further described below.

Control flow speculation involves branch prediction and related mechanisms to predict (and in cases of mis-prediction, recover) the direction of program flow. The objective is to maximize the presence of correct path instructions in the instruction window while minimizing or eliminating wrong path instructions.

Register renaming is used to alleviate problems associated with register dependencies where the number of registers available to instructions is small. Although a large physical register file, which is a hardware structure including a large number of physical registers, may be available in a processor, a smaller number of registers known as architectural or logical registers are made available to instructions executing on the processor to achieve compact instruction encoding and higher software efficiency. For example, to execute a program in a processor, a compiler may transform the program into assembly instructions. The assembly instructions may include or refer to names of logical registers in their encoding. However, the small number of logical registers can lead to register name dependencies (also known as false dependencies) which can limit the size of the instruction window, because more than one instruction in the window may need to access the same logical register.

To combat this limitation, register renaming may be employed, where the logical register names are mapped to the physical register names. Translations from logical to physical register names may be handled by a hardware table called a register rename table (RRT) or a rename map table (RMT). This hardware renaming mechanism may be invisible to software (e.g., the compiler). Based on the renaming, the instructions may effectively write their generated results or outputs, also known as “productions,” to the physical registers (which are part of a physical register file (PRF)). Any future consumers of these productions can also read the same physical registers. Since the number of physical registers available exceeds the number of logical registers, the renaming from logical to physical register names can alleviate the limitations imposed by dependencies. However, to read and write physical registers of the PRF in this manner, conventional implementations involve a large number of read and write ports in the PRF because many values may need to be read from the PRF in a single clock cycle and written to the PRF in a single cycle, which can increase the area and power consumption of the PRF.

With reference to FIG. 1, relevant aspects of a conventional processor, processor 100, are illustrated. Processor 100 may be an OOO processor. In further detail, pipeline stages of processor 100 are grouped into in-order stages 126 and OOO stages 128. Also shown are rename map table (RMT) 120, physical register file (PRF) 124, and ready (rdy) file 122, which will be explained below.

In-order stages 126 comprise fetch 106, decode 108, rename 110, and register access (RACC) 112 stages. In the fetch stage 106, an instruction fetch unit (not shown) of processor 100, for example, fetches instructions, for example, from an instruction cache (not shown in this view). In the decode stage 108, a decode unit (not shown) of processor 100, for example decodes the instructions to determine an instruction operation code (or “opcode”), and identify operands expressed in terms of logical register names, e.g., source and destination register names. In the rename stage 110, RMT 120, for example, maps the logical source and destination register names to physical register names. Conventionally, for renaming destination registers, a structure known as a “free list” (not shown) may be employed, which can supply the names of free (i.e., not in active use) physical registers. In the RACC 112 stage, processor 100 reads the physical registers corresponding to the source operands or source logical register names from PRF 124. Processor 100 also reads Rdy file 122 in parallel with reading PRF 124. Rdy file 122 holds entries corresponding to physical registers of PRF 124, wherein the entries of rdy file 122 show whether the physical registers of PRF 124 are ready or not. If a certain physical register is not ready (e.g., as identified by reading a corresponding entry of rdy file 122), this means that execution of an instruction responsible for producing the value of the physical register has not been completed. In such cases, the desired value may be received by a consumer instruction through one or more forwarding paths (not shown) which enable a value produced in a later pipeline stage to be provided to the consumer instruction in an earlier stage, before the value has been written to PRF 124 and the corresponding entry in Rdy file 122 has been set.

Coming now to OOO stages 128, dispatch 114, execute 116, and write back 118 stages are shown. In the dispatch stage 114, instruction(s) are dispatched to execution units (not shown) of processor 100, after identifying and possibly arbitrating among instructions that have all their source operands ready, and for which an appropriate execution unit is available. In the execute 116 stage, the dispatched instruction is executed in the execution unit and a result is generated, which may be referred to as the “production” as noted above. In the write back 118 stage, the dispatched instruction's production is written to the appropriate physical register (in PRF 124), which was assigned to the instruction in the rename stage 110. In addition, during the write back stage 118, processor 100 also writes or sets an entry corresponding to the physical register in rdy file 122 to indicate that the corresponding value or production is now available in the physical register. Also in the write back stage 118, the production may be forwarded (e.g., through an aforementioned forwarding path) to a consumer instruction which has passed a certain pipeline stage (e.g., RACC 112) where the consumer instruction may have been able to read the production from PRF 124.

As previously mentioned, conventional implementations of accessing PRF 124 for reads/writes involve a large number of ports. To further explain this, a number of read ports and write ports conventionally used in the above-described structures will now be discussed. Without loss of generality, FIG. 1 illustrates RMT 120 as comprising L entries, where L corresponds to the number of logical registers supported by the instruction set architecture (ISA) of processor 100. PRF 124, on the other hand, is shown to have X entries (where, in conventional designs, X may be 3-4 times the size of L, although X need not be an exact integer multiple of L). Now, considering the execution of instructions of a program by processor 100, at any point in the program's execution, there will be a committed (i.e., determinatively known or non-speculative) value associated with each of the L logical registers, which is also called the architectural register state, the committed register state, or the golden register state of a logical register. Conventionally, the golden state of each of the L logical registers is also stored in corresponding physical registers in the PRF 124, which takes up L of the X entries of PRF 124, leaving X−L entries to hold other values such as speculative register states associated with instructions in the instruction window.

In one example, in-order stages 126 (comprising the fetch 106, decode 108, rename 110, and RACC 112 stages) which form a front end of processor 100, may be F-wide, which means that they are capable of handling F instructions per cycle. OOO stages 128 (comprising the dispatch 114, execute 116, and write back 118 stages), which form a back end of processor 100 may be assumed to be B-wide, which means they are capable of dispatching and executing B instructions per cycle and, therefore, capable of writing back B productions per cycle. For conventional implementations, each instruction is assumed to have at most two source registers and at most one destination register. The number of read and write ports for RMT 120, PRF 124, and rdy file 122 are dependent on the numbers F and B noted above. The number of read and write ports are representatively shown in FIG. 1 by the letters “r” and “w,” respectively. As previously noted, the number of ports play a role in the number of entries or the size of each entry that can be stored in a corresponding file structure. For example, if there are fewer entries or smaller entry sizes, there may be room to support more ports in a file structure, whereas if there are a larger number of entries or larger entry sizes, a reduced number of ports may be supported. The interaction of the pipeline stages with RMT 120, PRF 124, and rdy file 122 and the corresponding impact on the number of ports will now be described based on an example process flow illustrated with numbered processes in FIG. 1.

Process 101: in the rename 110 stage, execution of up to F instructions, with 2 source operands each (expressed as logical registers), may entail accessing the current mappings of logical to physical register names in RMT 120, to identify the physical registers corresponding to the logical registers which form the source operands. Process 101 involves 2*F read ports (r) into RMT 120, since 2*F registers may need to be read from RMT 120 during the clock cycle corresponding to the rename stage 110.

Process 102: for the destination operands (also expressed as logical registers) of the up to F instructions, processor 100 may identify new destination physical registers, either in the rename 110 or RACC 112 stages, where these new destination physical registers replace old mappings to corresponding logical registers in RMT 120. Process 102 involves F write ports (w) in RMT 120. As previously mentioned, a free list (not shown) may be employed in order to quickly locate the physical registers that are free for use in this step.

Process 103: in the RACC 112 stage, processor 100 reads up to 2*F physical registers, corresponding to the physical source registers of the up to F instructions, from PRF 124. In parallel, processor 100 also reads the corresponding entries in rdy file 122. Process 103 involves 2*F read ports (r) in PRF 124 and 2*F read ports (r) in rdy file 122. It is noted that if an entry corresponding to a physical register is set in rdy file 122, the value read from PRF 124 is a valid physical register.

Process 104: in the write back 118 stage, processor 100 write back up to B productions to PRF 124, which involves B write ports (w) in PRF 124 since B productions may need to be written to B different registers in PRF 124 during the clock cycle corresponding to the write back stage 118. The corresponding entry in rdy file 122 is also set to indicate that the corresponding entry in PRF 124 now holds valid productions, which involves B write ports (w) in rdy file 122 as well.

As noted in the above discussion, making an instruction window larger can improve performance of processor 100. Additionally, making the pipeline stages wider (i.e., increasing the values of F and B in the case of processor 100, assuming corresponding improvements in branch prediction, memory access, etc.) can also lead to an increase in performance. On the other hand, making the pipeline stages wider is seen to increase the size of PRF 124 as well as the number of read/write ports of PRF 124 (since these directly depend on the values of F and B). A large, highly-ported PRF such as PRF 124 can lengthen cycle time or decrease the clock frequency of processor 100 and increase power consumption, especially when the number of logical registers supported by the ISA increases (since an increase in the number of logical registers increases the number of entries L and X of RMT 120 and PRF 124 respectively). Furthermore, in cases where processor 100 supports multiple program contexts, for example, where multi-threading architectures are supported, the number of entries and number of ports in the above structures, RMT 120, rdy file 122, and PRF 124 increases further.

With reference now to FIG. 2, a conventional approach to decreasing the number of ports on PRFs such as PRF 124 of FIG. 1 is described for yet another conventional processor, such as processor 200. Processor 200 is similar in many aspects to processor 100 and like-numbered reference numerals have been retained in FIG. 2 for similar aspects that were discussed above in FIG. 1 (a detailed description of the similar aspects will not be repeated, for the sake of brevity). Focusing on the differences, the design of processor 200 recognizes that only a bounded subset of entries of PRF 224 (corresponding to the most recent productions of each logical register) contains values of physical registers that will be needed in RACC 112 stage of processor 200. Accordingly, in RACC 112 stage, access is provided to only this subset, by means of a structure shown as future file (FF) 223. FF 223 retains an explicit copy of the most recent productions of each logical register in a structure separate from PRF 224, which allows the number of read ports in PRF 224 to be reduced. The read ports for the most recent productions of the logical registers are moved to FF 223 instead. FF 223 is shown to have L entries, where L is the number of logical registers supported by the ISA of processor 200. FF 223 is indexed by the logical register names and contains the latest production (even if it is speculative) associated with each logical register. A process flow for an example instruction with the inclusion of FF 223 will now be described with reference to the numbered processes shown in FIG. 2.

Processes 201 and 202 are the same as Processes 101 and 102 of FIG. 1 and therefore a further detailed description of these Processes will be omitted for the sake of conciseness.

Process 203: processor 200 reads the source operands (expressed as logical registers) for the instruction from FF 223. Processor 200 also reads rdy file 222 at this time, which is similar to Process 103 of FIG. 1. However, in this case, if entries of Rdy file 222 indicate that a corresponding value is ready, then the production read from FF 223 is accepted. On the other hand, if the corresponding value is not ready, then the production read from FF 223 is discarded, and, instead, the production is expected to arrive via a forwarding path (not shown).

Process 204: in write back 118 stage, processor 200 writes all productions to PRF 224 and the corresponding entries in rdy file 224 are set, similar to Process 104 of FIG. 1. However, in this case, additional operations are performed, where some of the productions may also be written back to FF 223 as follows. In write back 118 stage, RMT 220 is read in order to determine if the logical to physical register mapping for each production being written back is still valid in RMT 220, indicating that a given production is still the most recent version of the corresponding logical register. If the mappings are valid, then the production is written into FF 223 (in addition to being written back to PRF 224). In addition, similar to Process 104 of FIG. 1, the productions are forwarded to consumers which have passed RACC 112 stage (e.g., via forwarding paths, not shown), keeping in mind that any future consumers of the productions written into FF 223 will read those productions out of FF 223 in RACC 112 stage. The productions that are not written into FF 223 are only needed in case of state recovery, for example, in case there was a mis-speculation of control flow.

It is seen that the number of read/write ports of the various storage structures of processor 200 differ from those of processor 100 due to the introduction of FF 223.

Specifically, the number of read ports (r) of RMT 220 increases from 2*F (in the case of RMT 120 of processor 100) to 2*F+B. This increase is to account for RMT 220 being read in write back 118 stage (Process 204) in order to decide whether to write to FF 223 or not. However, the number of read ports (r) of PRF 224 can be reduced from 2*F, since PRF 224 is only read during recovery if there is a mis-speculation. The number of write ports (w) of PRF 224 remains B since processor 200 writes all productions to PRF 224 in Process 204.

Coming now to the read/write ports of FF 223, the number of read ports (r) of FF 223 is 2*F since all source operands are read from FF 223 (Process 203, although some may be discarded based on corresponding indications provided by the entries of Rdy file 222). Since processor 200 may potentially write all productions to FF 223 (Process 204), the number of write ports of FF 223 is B. Thus, it is seen that even though the number of read ports on PRF 224 is reduced, thus allowing the size of PRF 224 to be smaller, the size of FF 223 itself may be large because of the 2*F read ports in FF 223. The size of FF 223 may also increase if the number of logical registers L supported by the ISA increases. Moreover, if there are multiple program contexts at once (e.g., in a multi-threaded architecture) then the number of RMTs may be increased to support the multiple contexts (or the size of a single RMT to support the multiple threads). Further, the number of entries in RMT 220, for example, may grow in proportion to the number of logical registers L supported by the ISA. As the number of logical registers L supported by the ISA grows (or as the number of program contexts supported increase) the number of ports on RMT 220 increases, since in Process 204 in write back 118 stage, RMT 220 is checked in order to determine whether or not to write to FF 223.

Accordingly, there is a need in the art for reducing the size and number of ports on the physical register file while maintaining scalability of the register file system and adequate performance of the processor.

### SUMMARY

Exemplary aspects of the disclosure are directed to systems and methods relating to a hierarchical register file system, where a processor is coupled to a level 1 physical register file (L1 PRF) and a backing physical register file (PRF). Productions of instructions executed in an instruction pipeline of a processor which have a high likelihood of use for one or more future instructions are determined. While all productions are stored in the backing PRF, the productions which have a high likelihood of future use are selectively stored in the L1 PRF. Thus, the number of read ports and size of the backing PRF may be reduced.

For example, an exemplary aspect relates to a method of managing a hierarchical register file system, the method comprising: identifying a subset of productions of instructions executed in an instruction pipeline of a processor which have a high likelihood of use for one or more future instructions, storing the subset of productions in a level 1 physical register file (L1 PRF), and storing all productions in a backing physical register file (PRF).

Another exemplary aspect relates to an apparatus comprising a processor and a hierarchical register file system. The hierarchical register file system includes a level 1 physical register file (L1 PRF) configured to store a subset of productions of instructions executed in an instruction pipeline of the processor which are identified to have a high likelihood of use for one or more future instructions, and a backing PRF configured to store all productions.

Yet another exemplary aspect relates to a processing system comprising means for identifying a subset of productions of instructions executed in an instruction pipeline of a processor which have a high likelihood of use for one or more future instructions; first means for storing the subset of productions; and second means for storing all productions.

Another exemplary aspect relates to non-transitory computer readable storage medium comprising: a first instruction executable by a processor to generate a first production specified by a first logical register, the first logical register associated with a first physical register; and a second instruction executable by the processor to generate a second production specified by the first logical register, the first logical register associated with a second physical register. Both the first and second productions are determined to have a high likelihood of future use and are stored in a level 1 physical register file (L1 PRF) of the processor. All productions are stored in a backing PRF of the processor.

### BRIEF DESCRIPTION OF THE DRAWINGS

FIG. 1 illustrates a conventional processor.

FIG. 2 illustrates a conventional processor comprising a conventional future file.

FIG. 3 illustrates an exemplary processing system comprising a hierarchical register file system according to aspects of this disclosure.

FIG. 4 illustrates a method of managing a hierarchical register file system according to aspects of this disclosure.

FIG. 5 illustrates an exemplary wireless device 500 in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In exemplary aspects, a hierarchical physical register file (PRF) design is provided. In exemplary aspects, it is recognized that temporal locality exists among logical registers used by a program. Thus, even though an instruction set architecture (ISA) may support L logical registers in total, at any given phase of a program or within an instruction window, a smaller subset of logical registers are likely to be in active use.

An exemplary level 1 physical register file (L1 PRF) is provided as a cache of a main or backing PRF (it is noted that the main/backing PRF may also be simply referred to as “the PRF” in this disclosure). As will be recalled, “productions” are outputs of instructions executed in an instruction pipeline of a processor. Some productions may be consumed by future instructions. The productions may be expressed using logical register names (or stored in logical registers) which map to physical registers of the backing PRF. In exemplary aspects, a subset of the productions, corresponding to productions of instructions which have a high likelihood of future use or high likelihood of use for the future instructions are identified. The subset of the productions which are identified as productions which have a high likelihood of future use are selectively stored in the L1 PRF, while all the productions are stored in the backing PRF. Thus, the subset of productions which are stored in the L1 PRF can be read out from the L1 PRF without accessing the backing PRF, thus allowing the number of read ports in the backing PRF to be reduced. An exemplary write filter comprises information regarding logical to physical register mappings, based on which, any renames of logical registers to physical registers (which may take place, for example, during the execution of an instruction), can be tracked. Likelihood of future use for logical registers corresponding to productions can be based on whether the logical register to physical register mappings remain the same or of the mappings are altered. Thus, using the write filter, the subset of the productions which have a high likelihood of future use (e.g., logical register of productions, whose mappings to physical registers are not altered within a time period under consideration) are identified, and this subset of the productions are written to the L1 PRF. The productions which do not have a high likelihood of future use (e.g., physical registers corresponding to logical registers of productions, whose mappings to physical registers are altered during the time period under consideration) are written back only to the backing PRF. In this manner, the write filter serves as a device used to filter the productions which are written to the L1 PRF.

In exemplary aspects, the subset of productions stored in the L1 PRF may correspond to a subset of logical registers supported by the ISA. The productions stored in the L1 PRF may include only the latest renames of logical registers held in the L1 PRF in some cases. In some cases, the L1 PRF may hold more than one version or rename of the logical registers (e.g., mappings to two or more physical registers for the same logical register). Alternatively, storing the subset of productions (which have a high likelihood of future use) in the L1 PRF can also be accomplished by storing, in the L1 PRF, a subset of physical registers of the backing PRF. Although it is possible for the physical registers stored in the L1 PRF to map to all available logical registers, in exemplary aspects, only a subset of logical registers supported by an ISA may map to the subset of physical registers stored in the L1 PRF. Regardless of whether logical or physical registers are stored, in exemplary aspects, a small number of entries which correspond to productions with high likelihood of future use are selectively stored in the L1 PRF. The below description focuses on aspects where the productions stored in the L1 PRF are in terms of logical registers, while keeping in mind that storing the productions in terms of corresponding physical registers to which the logical registers are mapped is also possible.

As such, it is seen that where the L1 PRF is configured to hold productions in terms of the logical registers, the exemplary L1 PRF can hold two or more versions or renames of the same logical register (e.g., which have mappings to different physical registers). In some aspects, entries of the L1 PRF may be tagged based on the physical register name that a logical register name maps to, and indexed using the logical register name, for example, in a set-associative manner. By only holding the productions which have a high likelihood of future use, the L1 PRF can be small in size and provide adequate performance. The above exemplary aspects are described in further detail with reference to the figures below.

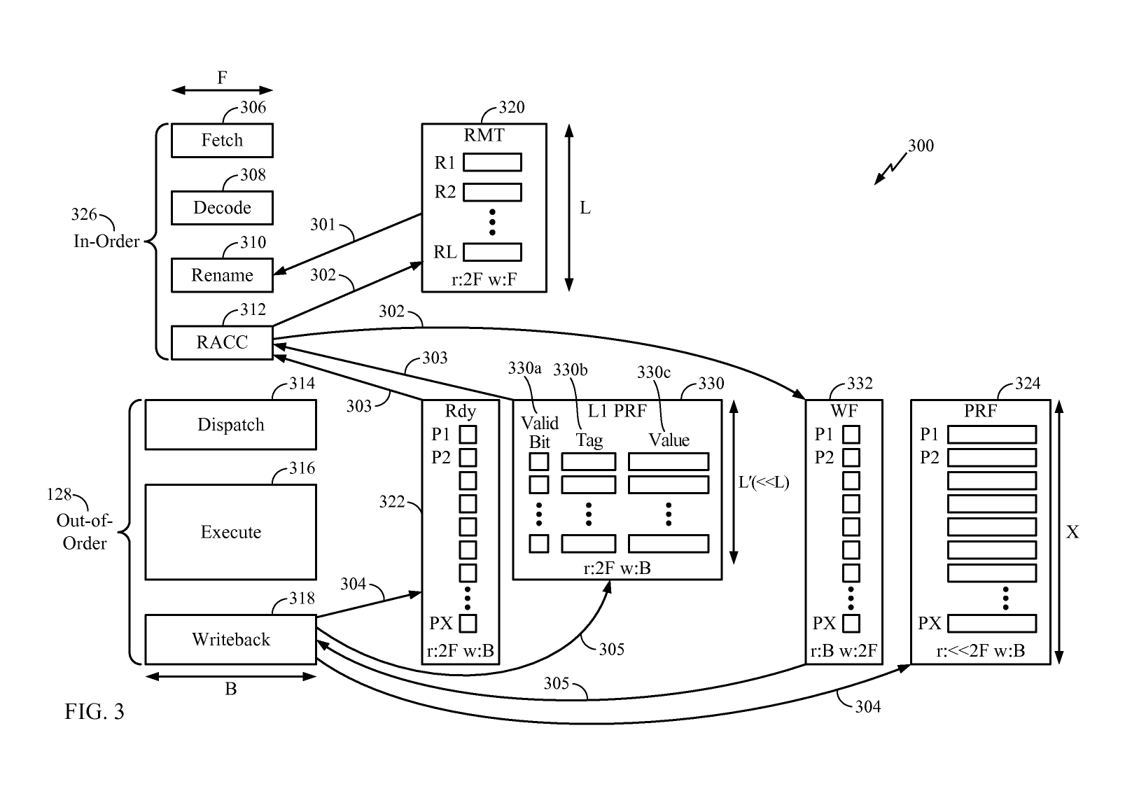

With reference now to FIG. 3, exemplary processor 300 is illustrated. Processor 300 may be a pipelined out-of-order (OOO) processor with pipeline stages similar to those of conventional processors 100 and 200. For example, processor 300 may have F-wide in-order stages 326 comprising fetch 306, decode 308, rename 310, and register access (RACC) 312 stages which are similar to in-order stages 126 comprising fetch 106, decode 108, rename 110, and RACC 112 stages of processors 100 and 200 described previously, and as such, a detailed description of these will not be repeated. Similarly, B-wide OOO stages 328 comprising dispatch 314, execute 316, and write back 318 stages are similar to OOO stages 128 comprising dispatch 114, execute 116, and write back 118 stages, and as such, a detailed description of these will also not be repeated.

Focusing on exemplary aspects, L1 PRF 330 and accompanying write filter (WF) 332 are shown in FIG. 3. L1 PRF 330 is configured to hold productions which have a high likelihood of future use. As shown, L1 PRF 330 is configured to hold logical registers corresponding to productions which have a high likelihood of future use. Correspondingly, WF 332 is configured to track mappings of logical registers to physical registers, based on which, logical registers having a high likelihood of future use can be identified. Example features and operation of L1 PRF 330 are explained below.

The size of L1 PRF 330 can be configured such that L1 PRF 330 can hold a small number of entries corresponding to only the logical registers which have a high likelihood of future use. For example, L′ is representatively shown as the number of entries in L1 PRF 330, where L′ may be smaller than the total number of logical registers L supported by an instruction set architecture (ISA) of processor 300. L1 PRF 330 is not restricted to a particular minimum required size and may be tailored according to specific power and performance needs of exemplary processors. In some aspects, a minimum size of or the number entries of L1 PRF 330 may be determined based on likely delays caused by misses in L1 PRF 330. For example, if there is miss in L1 PRF 330 for a particular register access, a main or backing PRF 324 may need to be accessed, which may have a variable latency of one or more clock cycles based on particular processor implementations. Thus, the size of L1 PRF 330 may be chosen in exemplary aspects to reduce the performance effect of such misses.

Further, L1 PRF 330 may be a tagged structure, in the sense that entries of L1 PRF may comprise tags. As previously mentioned, L1 PRF 330 may hold two or more versions or renames of a single logical register. Accordingly, a fully associative or a set-associative tagging mechanism may be employed. In one aspect, an entry of L1 PRF 330 may comprise a tag based on the physical register name associated with each production of a logical register. With reference to FIG. 3, L1 PRF 330 is shown to have multiple columns or fields for each entry, including tag 330b, which may hold the tag (e.g., a subset of bits of the physical register name) to help locate the desired production; and value 330c, which may hold the production (e.g., data value of the logical register identified by the tag 330b).

In some exemplary aspects, L1 PRF 330 may implement a valid bit associated with each entry stored in L1 PRF 330. As shown, valid 330a is a field which may hold the valid bit. The valid bit corresponding to a logical register stored in an entry of L1 PRF 330 may be used to indicate whether the logical register has a valid mapping to a physical register in the backing PRF 324. In this context, a valid mapping of a logical register to a physical register means that the mapping is the most recent version, or in other words, the mapping of the logical register to a physical register has not changed.

As already described, L1 PRF 330 can hold two or more versions of a single logical register, rather than being limited to holding only the latest production of each logical register.

WF 332 comprises a file or array of X number of 1-bit entries, where X is the number of physical registers in PRF 324. When an entry of WF 332 is set to 1, this indicates that a corresponding entry in PRF 324 holds (or will hold) the latest production corresponding to the latest mapping of a physical register to a particular logical register. Thus, the write filter WF 332 and the backing PRF 324 comprise a same number of entries, wherein each entry of WF 332 is configured to indicate if a corresponding entry of PRF 324 holds a physical register comprising a latest production.

Therefore, it will be noted that during the execution of instructions in processor 300, there will be L entries in WF 332 which are set to 1, with all other entries cleared or set to 0.

An exemplary process flow is now described with reference to the sequence of numbered processes illustrated in FIG. 3.

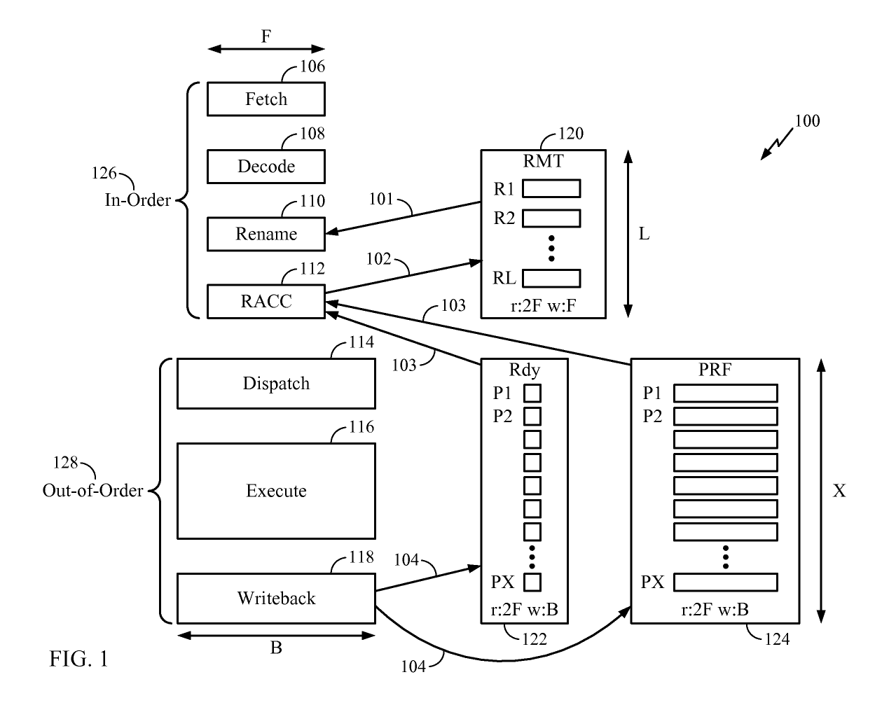

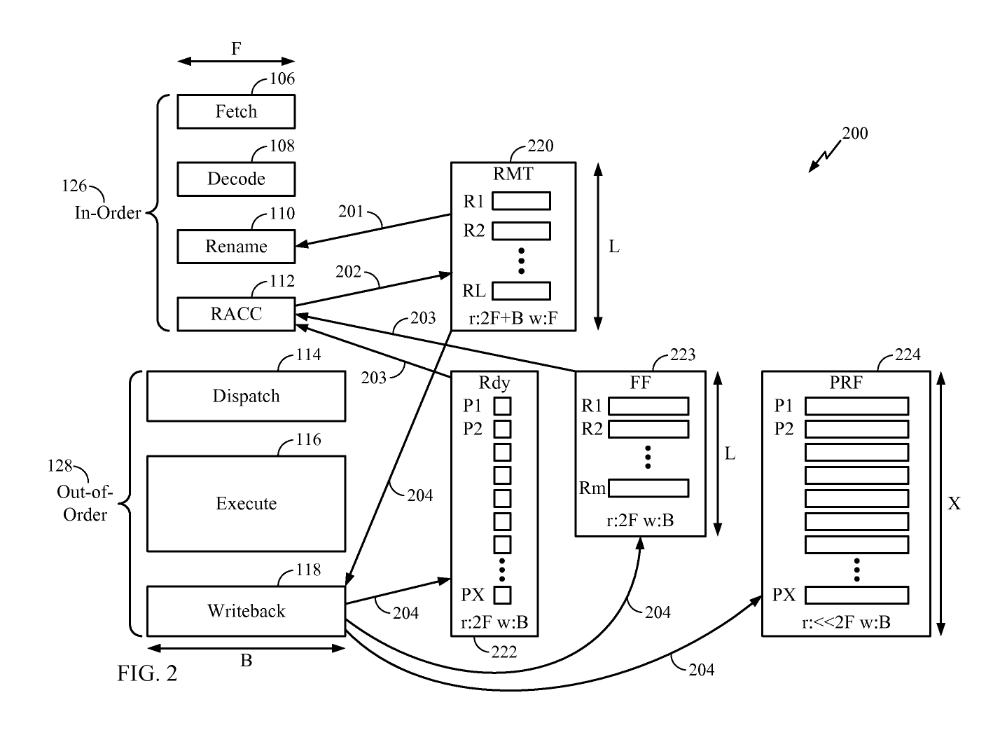

Process 301 may be similar to Processes 101 and 201 of FIGS. 1 and 2, respectively. Specifically, process 301 is performed upon one or more (up to F) instructions passing through the fetch 306 and decode 308 stages. The F instructions can have two source operands each (expressed as logical registers), in the example shown, although some instructions can have more or less source operands. In the rename 310 stage, processor 300 is configured to access RMT 320 to identify the physical registers corresponding to the source operands expressed as the logical registers. Accordingly, Process 301 involves 2*F read ports (r) in RMT 320. In the context of this disclosure, the identification of a physical register corresponding to a logical register, or in other words, the mapping of a logical register to a physical register in the rename 310 stage is referred to as the original mapping assigned to the logical register.

In Process 302, new destination physical registers are identified for the destination registers or targets (also expressed as logical registers) of the up to F instructions, either in the rename 310 stage or the RACC 312 stage. The new destination physical register names replace old mappings of corresponding logical registers in RMT 320, which involves F write ports (w) in RMT 320. Once again, a free list (not shown) may be employed in order to quickly locate the physical registers that are free for use in Process 302. Additionally, in Process 302, WF 332 is updated to reflect the latest renames for the destination registers that were renamed in Process 302. For example, if a logical register name R1 was previously mapped to a physical register name P1 of PRF 324, and in Process 302, the mapping of R1 was changed to P2 of PRF 324, then the entry corresponding to P1 in WF 332 is cleared or set to 0 and the entry corresponding to P2 in WF 332 is set to 1. Therefore, the number of write ports (w) for WF 332 is shown as 2*F in this example (one write port for clearing one entry and another write port for setting another entry for each of the F instructions).

Process 303: in the RACC 312 stage, processor 300 reads the entries of rdy file 322 corresponding to the 2*F logical registers for the source operands. Processor 300 reads the productions from L1 PRF 330, rather than from PRF 324. It is noted that only the productions marked ready (i.e., for entries which are set to 1) in rdy file 322 are read from L1 PRF 330 at this stage, since the remaining productions may be acquired through forwarding paths (not shown). In some aspects, the ready productions associated with source logical registers will be available in L1 PRF 330. On the other hand, if an entry of rdy file 322 indicates that a logical register is ready, but the logical register is not available in L1 PRF 330 (i.e., in the case of a miss), then processor 300 will access the main or backing PRF 324 for the physical register which maps to the logical register corresponding to the production. However, L1 PRF 330 is designed in exemplary aspects to minimize misses, and therefore read accesses to main PRF 324 will be minimized (thus providing the capability to reduce the number of read ports in PRF 324). For example, even if L1 PRF 330 has 2*F read ports, main PRF 324 can be designed with a much smaller number of read ports than 2*F because main PRF 324 will be read only upon a miss in the L1 PRF 330. Thus, the number of read ports of PRF 324 can be designed, in some aspects, based on a number of misses that may be encountered by L1 PRF 330 and the latency or number of clock cycles required to supply a value from PRF 324 to RACC 312 stage. As such, in some aspects, L1 PRF 330 and PRF 324 can be designed such that PRF 324 is removed from the critical path with respect to register access, which can allow a reduced number of ports on PRF 324.

Process 304: in write back 318 stage, processor 300 writes all productions (i.e., B results after the F instructions pass through dispatch 314 and execute 316 stages) to the main or backing PRF 324. Entries of rdy file 322 corresponding to the productions written to PRF 324 are updated or set in Process 304, which involves B write ports (w) in PRF 324 and B write ports (w) in rdy file 322. Further, some productions are selectively stored in L1 PRF as discussed below.

Process 305: in write back 318 stage, processor 300 determines whether a particular production should also be written back to L1 PRF 330, and if so, the production is selectively stored in L1 PRF 330. Processor 300 determines whether a production should also be written back to L1 PRF 330 by reading the entries of WF 332 corresponding to the physical registers being written in write back 318 stage. If the corresponding entry in WF 332 is set, then processor 300 writes back the corresponding value (value 330c) and the tag (tag 330b, based on the physical register name of the production) to in L1 PRF 330, since the logical to physical mapping for this production is still valid. If, however, the corresponding entry is not set in WF 332, then the production is not stored in L1 PRF 330.

To further explain the above aspects, the process of writing back (also referred to as, selectively storing) productions in L1 PRF 330 may be contingent on whether a production is destined to be stored in a physical register of PRF 324 which corresponds to the latest physical register name for a logical register corresponding to the production. If the production is the latest, then it is likely that future consumers may use the production (e.g., younger instructions whose source operands use the latest production). In an exemplary aspect, if the production is still the latest physical register name for a particular logical register name several cycles after rename 310 stage, it is determined that the production has a high likelihood of future use. Accordingly, L1 PRF 330 is configured to be capable of holding two or more productions of the same logical register.

Accordingly, in an exemplary aspect WF 332 has B read ports (r) and L1 PRF 330 has (at most) B write ports (w). However, it will be understood by those skilled in the art that alternative designs with fewer write ports (w) into L1 PRF 330 are within the scope of this disclosure (e.g., if arbitration is employed at write back 318 stage to decide which productions are to be written into L1 PRF 330).

In alternative aspects, processor 300 may write back productions to L1 PRF 330 not only at write back 318 stage as described above, but also in RACC 312 stage when L1 PRF 330 is looked up, but the lookup does not provide a hit (see discussion of Process 303 above). However, it will be noted that in these aspects, additional write ports may be added to L1 PRF 330 if write backs of productions into L1 PRF 330 can be performed in both write back 318 and RACC 312 stages.

To further explain the above features, an example instruction sequence is considered, wherein a logical register R1 stores a production of instruction A, and logical register R1 is not overwritten by another instruction for a long time. If logical register R1 was originally mapped to physical register P1 at rename 310 stage, and assuming that when instruction A completes, logical register R1 continues to be mapped to physical register P1, then instruction A is allowed to store the production of logical register R1 (mapped to physical register P1) into L1 PRF 330.

At a later stage, instruction B also produces or writes to logical register R1. However, in this case, logical register R1 is originally mapped to physical register P2. If, for example, there are no productions of logical register R1 for a long time, when instruction B completes, at write back 318 stage, instruction B may find that logical register R1 continues to be mapped to physical register P2 and accordingly writes the production of logical register R1 corresponding to the mapping to physical register P2 in L1 PRF 330.

At this point in time, it is seen that L1 PRF may hold productions of logical register R1 corresponding to mappings to both physical registers P1 and P2 (corresponding to instructions A and B). Moreover, both productions of logical register R1 may have their corresponding entries in rdy file 322 set (i.e., corresponding to physical registers P1 and P2). Thus, it is seen that L1 PRF 330 is capable of not only providing the latest production of logical register R1 corresponding to physical register P2 to the future consumers, but also capable of providing the production of logical register R1 corresponding to physical register P1 (e.g., in case there is a mis-speculation at some point after the production of logical register R1 corresponding to physical register P2 was written to L1 PRF 330 and processor 300 may need to recover).

Continuing with the example instruction flow, it is possible that at some future point, physical register P1 is returned to the aforementioned free list to indicate that it is available (e.g., if enough time has passed and physical register P1 may no longer be needed even for the purpose of recovery from possible mis-speculations). When physical register P1 is returned to the free list in this manner, the corresponding entry in rdy file 322 will be cleared. However, it may now be possible that yet another new production of a logical register R1 may become mapped to physical register P1, since physical register P1 was returned to the free list. If this new production is allowed to write to L1 PRF 330 without additional controls, then a future consumer may be confused because multiple versions of physical register P1 may now remain in L1 PRF 330 corresponding to logical register R1 (it is noted that although physical register P1 was returned to the free list from RMT 320, this change was not reflected in L1 PRF 330 in the above-described example, and since L1 PRF 330 is tagged with the physical register names and indexed with logical register names, multiple entries may be found for the same logical register name R1 mapped to the same physical register name P1).

In order to avoid the above confusion, exemplary aspects include additional checks/control features which will now be described in detail. In one aspect, the previously discussed “valid” bit in the field valid 330a for each entry of L1 PRF 330 is utilized. The valid bit is cleared (or invalidated) whenever a physical register is returned to the free list. Only entries whose valid bits which are set will return a hit in L1 PRF 330. Accordingly, a future consumer of P1 will be prevented from looking at an invalid version because the invalid version of P1 will not produce a hit. In a second aspect, a second write to the same physical register P1 is caused to overwrite an existing entry which is tagged by the same physical register P1, if such an entry exists. In order to implement the second aspect, L1 PRF 330 is accessed during a write (e.g., the second write) to determine if an entry (e.g., indexed by logical register R1) has tag 330b corresponding to physical register P1. If so, then the write is caused to overwrite the entry tagged by physical register P1. As seen, the second aspect may involve reading tags at the same time that a write operation is to be performed to L1 PRF 330. However, reading and writing at the same time may involve additional read ports or additional write ports being added to L1 PRF 330, and therefore, the second aspect may involve increasing the size of L1 PRF 330.

In some aspects, for removing entries from L1 PRF 330 or for replacing existing entries with new entries in L1 PRF 330 (e.g., in order to create space) replacement policies such as least recently used (LRU), pseudo-LRU, reuse-based algorithms, decay counter based algorithms, etc. may be used. Active invalidation of certain entries may also be used in some aspects, where, for example, either periodically or upon hitting a threshold utilization of L1 PRF 330, WF 332 may be read to identify if any space in L1 PRF 330 is being utilized by non-latest mappings for any logical register. In cases where there may be two or more versions of at least one logical register residing in L1 PRF 330, all versions except for the latest version of the at least one logical register (i.e., the versions with the corresponding entry in WF 332 cleared), can be invalidated.

As previously noted, in some cases, recovery mechanisms may be adopted if there was a mis-speculation in control flow and instructions down an incorrect path were executed. Known techniques may be used for recovering the state of RMT 320 (and correspondingly, the entries of rdy file 322 which indicate which physical registers of PRF 324 hold valid data). In exemplary aspects, entries of WF 332 are recovered in parallel as well. For example, if a recovery process sends the mapping of logical register R1 from physical register P2 back to physical register P1, the entry of WF 332 corresponding to physical register P2 is cleared and the entry of WF 332 corresponding to physical register P1 is set. As can be seen, this process is similar to the process described above at rename 310 stage (Process 302) during normal operation (e.g., when processor 300 is not in recovery mode). Moreover, it is to be noted that as physical registers are returned to the free list during a recovery process, the valid bit of the corresponding entries in L1 PRF 330 are also cleared, as described earlier. Thus, the valid bit associated with a logical register stored L1 PRF 330 is also invalidated if an instruction which produced the logical register was mis-speculated.

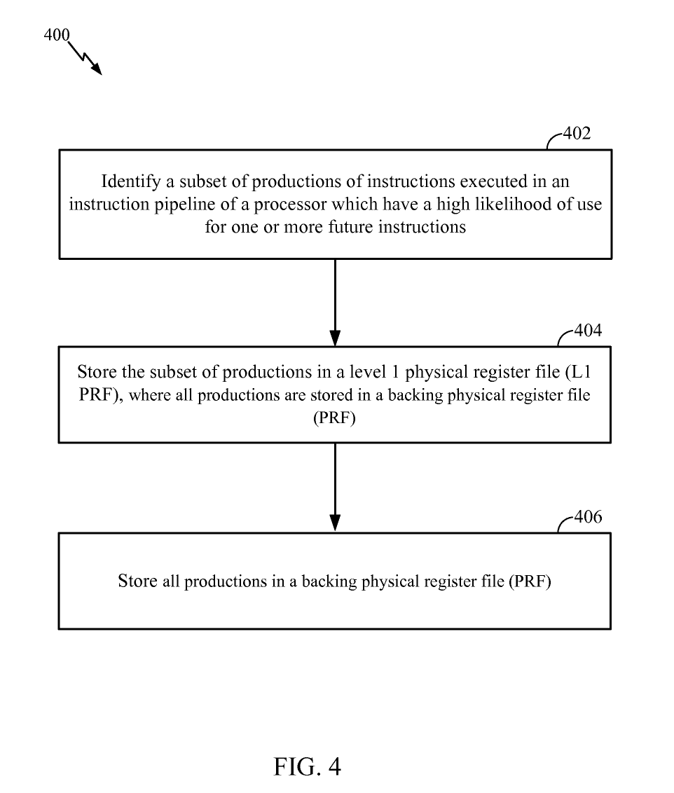

Accordingly, it will be appreciated that aspects include various methods for performing the processes, functions and/or algorithms disclosed herein. For example, FIG. 4 illustrates a method (400) of method of managing a hierarchical register file system according to exemplary aspects. The various steps or blocks of method 400 are explained below.

Block 402 comprises identifying a subset of productions of instructions, executed in an instruction pipeline of a processor (e.g., processor 300), which have a high likelihood of use for one or more future instructions. For example, the subset of productions may be identified based on comparing the mapping of a logical register (corresponding to the production) to a physical register from when a corresponding instruction was fetched (or more precisely, in the rename stage 310, when processor 300 determines the mapping of the logical register to the physical register using RMT 320) to when execution of the instruction is completed. If the mapping has not changed, then the production is deemed to have a high likelihood of future use. In more detail, for a first production of a first instruction which is expressed as a first logical register, it may be determined that the first production has a high likelihood of future use by determining that a mapping of the first logical register to a first physical register when execution of the first instruction was completed to generate the first production is the same mapping as when the first instruction was fetched in the instruction pipeline. Determining that the mapping has remained the same may be based, for example, by using a write filter (e.g., WF 332) to track mappings of logical registers to physical registers. The write filter may comprise entries corresponding to physical registers stored in a backing physical register file (e.g., PRF 324), the entries of the write filter indicating whether the corresponding physical registers hold latest values for a corresponding logical register. Accordingly, the mapping of the first logical register to the first physical register is the same if the write filter holds a first entry corresponding to the first physical register or, as described herein, if the first entry in the write filter is set.

Block 404 comprises storing, in a level 1 physical register file (e.g., L1 PRF 330), the subset of the productions and Block 406 comprises storing all productions in a backing physical register file (e.g., PRF 324). Accordingly, exemplary aspects of accessing the hierarchical register file system include accessing only the L1 PRF, but not the backing PRF, for reading productions stored in the L1 PRF; and accessing the backing PRF for reading productions which are not stored in the L1 PRF (i.e., which miss in the L1 PRF). In some aspects storing the subset productions which have a high likelihood of future in the L1 PRF may involve storing a subset of logical registers supported by an instruction set architecture (ISA) of the processor, the logical registers mapped to physical registers of the backing PRF. When storing logical registers, it may be possible for two or more versions (e.g., mappings to different physical registers) of a logical register to be stored, while in some cases storing only a latest rename or mapping of each of the logical registers of the subset of logical registers in the L1 PRF may be allowed. In some aspects, the subset of productions stored in the L1 PRF may include a subset of physical registers of the backing PRF.

Thus, a hierarchical register file system can be managed according to method 400, wherein an L1 PRF with fewer entries than a backing PRF can be accessed for the subset of productions which have a high likelihood of future use, while not accessing the backing PRF for the subset of productions. This saves read ports on the backing PRF, thus reducing the size and complexity of the backing PRF.

It will also be appreciated from the above disclosure that a processing system is disclosed in exemplary aspects, where the processing system includes means for identifying a subset of productions of instructions executed in an instruction pipeline of a processor which have a high likelihood of use for one or more future instructions. Such means may include the aforementioned write filter (e.g., WF 332), whose entries, when set, may indicate productions which have a high likelihood of future use. The processing system may include first means (e.g., L1 PRF 330) for storing the subset of productions which have a high likelihood of future use, and second means for storing all productions (e.g., backing PRF 324). As such, the first means and second means may be in a hierarchical relationship, where the first means is configured to store a subset of logical registers supported by an instruction set architecture (ISA) of the processing system, wherein the subset of logical registers are mapped to physical registers of the second means. In an exemplary aspect, the first means can be configured to store only a latest rename or mapping of the subset of logical register. As seen, in some aspects the processing system may include means for indicating whether the physical registers of the second means correspond to latest values for logical registers of the first means (e.g. WF 332).

Accordingly, a further aspect of this disclosure can include a computer readable media embodying first and second instructions executable by a processor (e.g. processor 300). The first instruction generates a first production expressed as (or stored in) a first logical register, the first logical register associated with a first physical register. The second instruction generates a second production specified by the first logical register, the first logical register associated with a second physical register. Both first and second productions are determined to have a high likelihood of future use and are stored in a level 1 physical register file (e.g., L1 PRF 330) of the processor. All productions are stored in a backing physical register file (e.g., PRF 324) of the processor. Accordingly, the invention is not limited to illustrated examples and any means for performing the functionality described herein are included in aspects of this disclosure.

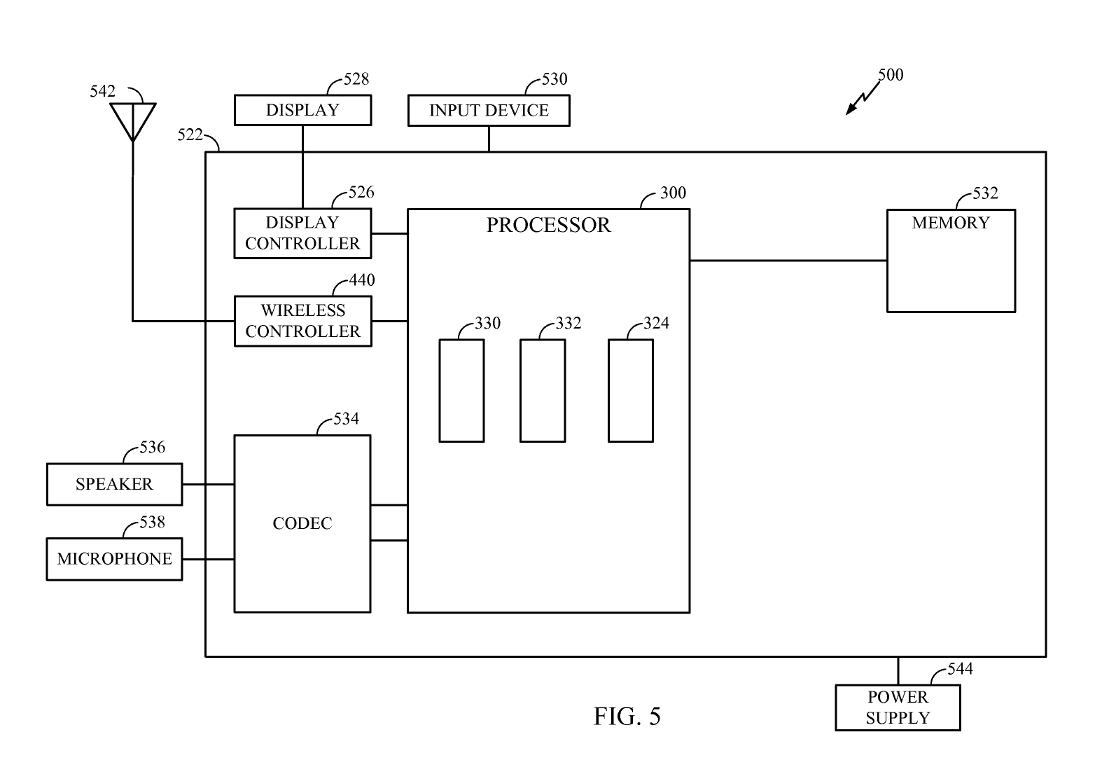

Referring to FIG. 5, a block diagram of a particular illustrative aspect of wireless device 500 according to exemplary aspects. Wireless device 500 includes processor 300 described with reference to FIG. 3 (with only blocks representing exemplary structures corresponding to PRF 324, L1 PRF 330, and WF 332 are shown for the sake of clarity in this representation). Processor 300 may be configured to perform the method 400 of FIG. 4 in some aspects. As shown in FIG. 5, processor 300 may be in communication with memory 532, which in some aspects may correspond to the non-transitory computer readable storage medium described previously. Although not shown, one or more caches or other memory structures also corresponding to the non-transitory computer readable storage medium described previously may also be included in wireless device 500.

FIG. 5 also shows display controller 526 that is coupled to processor 300 and to display 528. Coder/decoder (CODEC) 534 (e.g., an audio and/or voice CODEC) can be coupled to processor 300. Other components, such as wireless controller 540 (which may include a modem) are also illustrated. Speaker 536 and microphone 538 can be coupled to CODEC 534. FIG. 5 also indicates that wireless controller 540 can be coupled to wireless antenna 542. In a particular aspect, processor 300, display controller 526, memory 532, CODEC 534, and wireless controller 540 are included in a system-in-package or system-on-chip device 522.

In a particular aspect, input device 530 and power supply 544 are coupled to the system-on-chip device 522. Moreover, in a particular aspect, as illustrated in FIG. 5, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 depicts a wireless communications device, processor 300 and memory 532 may also be integrated into a set top box, a music player, a video player, an entertainment unit, a navigation device, a personal digital assistant (PDA), a communications device, a fixed location data unit, a computer or other similar electronic devices. Further, at least one or more exemplary aspects of wireless device 500 may be integrated in at least one semiconductor die.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

While the foregoing disclosure shows illustrative aspects, it should be noted that various changes and modifications could be made herein without departing from the scope of this disclosure as defined by the appended claims. The functions, steps and/or actions of the method claims in accordance with the aspects described herein need not be performed in any particular order. Furthermore, although elements of the invention may be described or claimed in the singular, the plural is contemplated unless limitation to the singular is explicitly stated.

What is claimed is:

1. A method of managing a hierarchical register file system, the method comprising:
identifying a subset of productions of instructions executed in an instruction pipeline of a processor which have a high likelihood of use for one or more future instructions;
storing the subset of productions in a level 1 physical register file (L1 PRF); and
storing all productions in a backing physical register file (PRF).

2. The method of claim 1, wherein storing the subset of productions in the L1 PRF comprises storing a subset of logical registers supported by an instruction set architecture (ISA) of the processor in the L1 PRF, wherein the subset of logical registers are mapped to physical registers of the backing PRF.

3. The method of claim 2, further comprising storing two or more versions of at least one logical register of the subset of logical registers in the L1 PRF, the two or more versions corresponding to mappings of the at least one logical register to different physical registers.

4. The method of claim 3, further comprising tagging the subset of the logical registers stored in the L1 PRF based on names of physical registers to which the subset of the logical registers stored in the L1 PRF are mapped.

5. The method of claim 2, wherein storing the subset of productions in the L1 PRF comprises storing only a latest mapping of the subset of logical registers in the L1 PRF.

6. The method of claim 2, further comprising associating a valid bit with a logical register of the subset of logical registers stored in the L1 PRF, the valid bit for indicating whether the logical register has a valid mapping to a physical register.

7. The method of claim 6, comprising invalidating the valid bit associated with the logical register if an instruction which produced the logical register was mis-speculated.

8. The method of claim 1, wherein storing the subset of productions in the L1 PRF comprises storing a subset of productions corresponding to the physical registers of the backing PRF in the L1 PRF.

9. The method of claim 1, further comprising: determining that a first production of a first instruction, the first production expressed as a first logical register, has a high likelihood of future use based on determining that a mapping of the first logical register to a first physical register when execution of the first instruction was completed to generate the first production is the same as the original mapping assigned to the first logical register in a rename stage of execution of the first instruction in the instruction pipeline.

10. The method of claim 9, wherein determining that the mapping of the first logical register to the first physical register is the same as the original mapping is based on determining that a first entry corresponding to the first physical register in a write filter is set, wherein the write filter comprises entries corresponding to physical registers stored in the backing PRF.

11. The method of claim 1, further comprising accessing only the L1 PRF, but not the backing PRF, for reading the subset of productions stored in the L1 PRF.

12. The method of claim 1, further comprising accessing the backing PRF for reading productions which are not stored in the L1 PRF.

13. An apparatus comprising:
a processor; and
a hierarchical register file system comprising:
a level 1 physical register file (L1 PRF) configured to store a subset of productions of instructions executed in an instruction pipeline of the processor which are identified to have a high likelihood of use for one or more future instructions; and
a backing PRF configured to store all productions.

14. The apparatus of claim 13, wherein the L1 PRF is configured to store a subset of productions comprising a subset of logical registers supported by an instruction set architecture (ISA) of the processor, the subset of logical registers mapped to physical registers of the backing PRF.

15. The apparatus of claim 14, wherein the L1 PRF is configured to store two or more versions of at least one logical register of the subset of logical registers in the L1 PRF, the two or more versions corresponding to mappings of the at least one logical register to different physical registers.

16. The apparatus of claim 15, wherein the L1 PRF is configured to store tags associated with the subset of the logical registers stored in the L1 PRF, wherein the tags are based on names of physical registers mapped to the subset of the logical registers stored in the L1 PRF.

17. The apparatus of claim 14, wherein the L1 PRF is configured to store only a latest rename or mapping of each of the logical registers of the subset of logical registers stored in the L1 PRF.

18. The apparatus of claim 14, wherein the L1 PRF is configured to store a valid bit associated with a logical register of the subset of logical registers stored in the L1 PRF, wherein the valid bit is configured to indicate whether the logical register has a valid mapping to a physical register.

19. The apparatus of claim 18, wherein the valid bit associated with the logical register is configured to be invalidated if an instruction which produced the logical register was mis-speculated.

20. The apparatus of claim 13, wherein the L1 PRF is configured to store a subset of productions corresponding to physical registers of the backing PRF.

21. The apparatus of claim 13, further comprising a write filter configured to track mappings of logical registers to physical registers, wherein the backing PRF is configured to store physical registers.

22. The apparatus of claim 21, wherein the write filter and the backing PRF comprise a same number of entries, wherein each entry of the write filter is configured to indicate if a corresponding entry of the backing PRF holds a physical register comprising a latest production.

23. The apparatus of claim 13, integrated into a device selected from the group consisting of a set top box, music player, video player, entertainment unit, navigation device, wireless communications device, personal digital assistant (PDA), fixed location data unit, and a computer.

24. A processing system comprising:
means for identifying a subset of productions of instructions executed in an instruction pipeline of a processor which have a high likelihood of use for one or more future instructions;
first means for storing the subset of productions; and
second means for storing all productions.

25. The processing system of claim 24, wherein the first means is configured to store a subset of logical registers supported by an instruction set architecture (ISA) of the processing system, wherein the subset of logical registers are mapped to physical registers of the second means.

26. The processing system of claim 25, wherein the first means is configured to store only a latest rename or mapping of the subset of logical registers.

27. The processing system of claim 25 comprising means for indicating whether the physical registers of the second means correspond to latest values for logical registers of the first means.

28. A non-transitory computer readable storage medium comprising:
a first instruction executable by a processor to generate a first production specified by a first logical register, the first logical register associated with a first physical register; and
a second instruction executable by the processor to generate a second production specified by the first logical register, the first logical register associated with a second physical register,
wherein both the first production and second production are determined to have a high likelihood of future use and are stored in a level 1 physical register file (L1 PRF) of the processor, and
wherein all productions are stored in a backing PRF.
